(19) United States
(12) Patent Application Publication
(10) Pub. No.: US 2009/0316909 A1
(43) Pub. Date: Dec. 24, 2009

(54) UTILIZATION APPARATUS, SERVICER APPARATUS, SERVICE UTILIZATION SYSTEM, SERVICE UTILIZATION METHOD, SERVICE UTILIZATION PROGRAM, AND INTEGRATED CIRCUIT

(76) Inventors: Yuichi Futa, Osaka (JP); Masao Nonaka, Osaka (JP); Taichi Sato, Kyoto (JP); Kaoru Yokota, Hyogo (JP); Tetsuya Inoue, Kyoto (JP); Natsume Matsuzaki, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/132,084

(22) Filed: Jun. 3, 2008

(30) Foreign Application Priority Data
Jun. 4, 2007 (JP) 2007-147655

(51) Int. Cl. H04L 9/08; H04L 9/30

(52) U.S. Cl. 380/279

(57) ABSTRACT

Provided are a utilization apparatus, a server apparatus, and a key utilization system which enable the utilization apparatus to control deletion of the old key without using a secure clock and allow encrypted communications irrespective of whether the accessed server has updated its key or not. In key utilization system 1, one or more server apparatuses 5-1 to 5-n each provide service to an apparatus having an apparatus key corresponding with a server key. Update apparatus 2 distributes an update server key to each server apparatus and a new apparatus key to key utilization apparatus 3. CRL distribution apparatus 4 distributes to key utilization apparatus 3 a CRL indicating one or more server apparatuses which have completed key-updating. Key utilization apparatus 3 holds both the old and new apparatus key, judges whether the server apparatuses monitored using the CRL have completed key-updating, and if affirmative, deletes the old apparatus key.

### BACKGROUND OF THE INVENTION

(1) Field of the Invention

The present invention relates to updating keys in a system using public key encryption.

(2) Description of the Related Art

In recent years, more and more apparatuses such as household electric appliances and mobile phones are connected with one another over home networking and transmit/receive secret information such as passwords and contents via encrypted communications.

When performing such communications, a system based on public key encryption is likely to be applied.

In the above-mentioned system, each apparatus establishes SAC (Secure Authenticated Channel) with a communication counterpart when performing an encrypted communication. When establishing SAC, the version of the secret key of the apparatus itself and the version of the public key, which corresponds with the secret key, need to coincide with each other. During regular operations, these versions coincide with each other.

Here, in the system based on the public key encryption, the secret key used when the certificate authority issues a certificate is generally under strict control. However, in a case where the secret key of the certificate authority is insecure due to exposure by an attacker or the like, it becomes necessary to update the key pair of the certificate authority, the key pairs of the apparatuses and the servers in the system, and the public key certificates.

In such a case, if each of the apparatuses and the servers simply deletes the pre-update key (old key) after key-updating, the apparatuses and the servers are not able to share authentication keys in a case where the servers and the apparatuses do not match each other in their key version.

Patent Document 1 discloses a technique addressing this issue. According to the technique, a grace period is provided for the update key held by the key utilization apparatus, and both the old key and new key are held until the grace period is over. The key utilization apparatus uses both the old key and the update key during the grace period, and upon lapse of the grace period, deletes the old key and starts using the update key exclusively.

However, the technique according to Patent Document 1 requires a secure clock, which keeps accurate time, to delete the key reliably upon the lapse of the grace period. A secure clock is costly, in general, and causes an increase in manufacturing cost of the key utilization apparatus.

In addition, in a case where a server accessed by the key utilization apparatus does not update the server key by the end of the grace period, the server becomes unable to perform encrypted communication with the key utilization apparatus, as the key utilization apparatus deletes the old key.

The present invention was conceived in view of the above problems and aims to provide a utilization apparatus, a server apparatus, and a key utilization system which enable the utilization apparatus to, unlike the conventional method, control deletion of the old key without using a secure clock and to allow encrypted communications irrespective of whether or not the accessed server has updated the key.

Patent Document 1: Japanese Patent Application Publication No. 2001-345798.

### SUMMARY OF THE INVENTION

In order to solve the above-described problems, a utilization apparatus in accordance with an embodiment of the present invention receives service from one or more server apparatuses, each providing service in response to a request made with use of an apparatus key that corresponds with a server key. The utilization apparatus comprises a key storage unit storing an old apparatus key and a new apparatus key, an acquisition unit operable to acquire update completion information indicating one or more server apparatuses, each of which has completed key-updating by updating an old server key corresponding with the old apparatus key to a new server key corresponding with the new apparatus key, a judgement unit operable to make, with use of the update completion information, a comprehensive judgement on key-updating with respect to a group of at least one server apparatus, from which the utilization apparatus receives service, a deletion unit operable to, if a result of the comprehensive judgement indicates that the group has completed the key-updating, delete the old apparatus key, and a utilization unit operable to, if the result of the comprehensive judgement indicates that the group has completed the key-updating, receive service from, among the group, a server apparatus which has updated the old server key to the new server key, with use of the new apparatus key.

With the stated structure, the utilization apparatus in accordance with the embodiment of the present invention is able to delete the old apparatus key reliably upon updating of the server keys of the server apparatuses from which the utilization apparatus receives service.

In addition, even when the server apparatuses from which the utilization apparatus receives service include a server apparatus which has not completed the key-updating, the utilization apparatus is able to communicate with that server apparatus with use of the old apparatus key. Consequently, it is possible to avoid a situation where the key utilization apparatus is unable to communicate with a server apparatus and thus is unable to receive service from the server apparatus.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawing:

FIG. 1 is a block diagram showing a structure of a key utilization system of an embodiment of the present invention;

FIG. 2 is a block diagram showing a structure of an update apparatus of the embodiment of the present invention;

FIG. 3 is a block diagram showing a structure of a key utilization apparatus of the embodiment of the present invention is connected;

FIG. 4 is a block diagram showing a structure of a CRL distribution apparatus of the embodiment of the present invention;

FIG. 5 is a block diagram showing a structure of a server of the embodiment of the present invention;

FIG. 6 is a flowchart showing an operation of apparatus key update processing in the key utilization system;

FIG. 7 is a flowchart showing an operation of server key update processing in the key utilization system;

FIG. 8 is a flowchart showing an operation of CRL distribution processing in the key utilization system;

FIG. 9 is a flowchart showing the first half of key utilization processing in the key utilization system;

FIG. 10 is a flowchart showing the second half of the key utilization processing in the key utilization system;

FIG. 11 schematically shows the key utilization system before connection server keys are updated; and

FIG. 12 schematically shows the key utilization system after the connection server keys are updated.

### DESCRIPTION OF THE PREFERRED EMBODIMENT

The utilization apparatus in accordance with the embodiment of the claim 1 receives service from one or more server apparatuses, each providing service in response to a request made with use of an apparatus key that corresponds with a server key. The utilization apparatus comprises a key storage unit storing an old apparatus key and a new apparatus key, an acquisition unit operable to acquire update completion information indicating one or more server apparatuses, each of which has completed key-updating by updating an old server key corresponding with the old apparatus key to a new server key corresponding with the new apparatus key, a judgement unit operable to make, with use of the update completion information, a comprehensive judgement on key-updating with respect to a group of at least one server apparatus, from which the utilization apparatus receives service, a deletion unit operable to, if a result of the comprehensive judgement indicates that the group has completed the key-updating, delete the old apparatus key; and a utilization unit operable to, if the result of the comprehensive judgement indicates that the group has completed the key-updating, receive service from, among the group, a server apparatus which has updated the old server key to the new server key, with use of the new apparatus key.

The above-described update completion information may include identifiers of the one or more server apparatuses each of which has updated the old server key to the new server key, and the judgement unit (i) holds monitoring target information which includes identifiers of one or more server apparatuses monitored for key-updating and (ii) makes the comprehensive judgement using the identifiers included in the monitoring target information and the identifiers included in the update completion information.

According to the stated structure, the utilization apparatus can easily judge whether the server keys of the monitored server apparatuses have been updated by identifying the server apparatuses using identifiers.

The above-described judgement unit may make the comprehensive judgement that the group has completed the key-updating when a ratio of (a) a number of identifiers which are included in both the update completion information and the monitoring target information to (b) a number of the identifiers included in the monitoring target information is equal to or greater than a predetermined ratio.

According to the stated structure, it is possible to avoid a state where the old apparatus key of the key utilization apparatus remains continuously undeleted due to a part of the monitored server apparatuses, the server keys of which remain unupdated.

The judgement unit may include a registration subunit operable to, when the utilization apparatus accesses a server apparatus, (i) make a determination whether or not an identifier of the accessed server apparatus is included in the monitoring target information, and (ii) if the determination is negative, add the identifier of the accessed server apparatus to the monitoring target information, a deletion subunit operable to read the monitoring target information and delete, among the identifiers included in the monitoring target information, identifiers of server apparatuses which are less likely to be accessed by the utilization apparatus, and a judgement subunit operable to make the comprehensive judgement using the identifiers included in the monitoring target information and the identifiers included in the update completion information.

According to the stated structure, the key utilization apparatus can appropriately select and manage server apparatuses to be monitored.

Also, the key utilization apparatus adds the accessed server apparatus to the monitoring target information, and removes, from the monitoring target information, server apparatuses which are less likely to be accessed. Accordingly, for those server apparatuses which are less likely to be accessed, monitoring on key-updating becomes unnecessary, reducing a processing load as a result.

In addition, it is possible to avoid a state where the old apparatus key of the key utilization apparatus remains continuously undeleted due to un-updated server keys of the server apparatuses which are no longer accessed.

The above-described utilization unit, if the result of the comprehensive judgement may indicate that the group has not completed the key-updating, may receive designation of an apparatus key in accordance with a server key held by a server apparatus of the group, and utilizes the designated apparatus key.

According to the stated structure, the utilization apparatus can receive service from any one of the server apparatuses which have not updated the server keys and the server apparatuses which have updated the server keys.

Further, the key utilization apparatus can receive service continuously even in a case where the server apparatus updates the server key while the key utilization apparatus is receiving service.

A service utilization system in accordance with the embodiment of the claim 6 comprises one or more server apparatuses, an updating apparatus, and a utilization apparatus, each of the server apparatuses providing service in response to a request made with use of an apparatus key that corresponds with a server key, the updating apparatus distributing an update server key to each server apparatus, and the utilization apparatus receiving service using an apparatus key and a distribution apparatus which distributes update completion information indicating at least one server apparatus that has completed key-updating. Here, each of the server apparatuses includes a holding unit operable to hold an old server key, a key receiving unit operable to receive a transmission of a new server key, a key updating unit operable to perform the key-updating by replacing the old server key with the new server key; and a service providing unit operable to provide service, with use of the updated key held by the holding unit, to the utilization apparatus. The updating apparatus includes a generating unit operable to generate, for each of the server apparatuses, a new server key which corresponds with the new apparatus key, and a key transmitting unit operable to transmit the new server key to each of the server apparatuses. The distribution apparatus includes a collection unit operable to collect information on the at least one server apparatus which has completed the key-updating, and a distribution unit operable to generate the update completion information and distribute the generated update completion information to the utilization apparatus. The utilization apparatus includes a key storage unit storing an old apparatus key and a new apparatus key, an acquisition unit operable to acquire the update completion information, a judgement unit operable to make, with use of the update completion information, a comprehensive judgement on key-updating with respect to a group of at least one server apparatus, from which the utilization apparatus receives service, a deletion unit operable to, if the result of the comprehensive judgement indicates that the group has completed the key-updating, delete the old apparatus key, and a utilization unit operable to, if the result of the comprehensive judgement indicates that the group has completed the key-updating, receive service from, among the group, a server apparatus which has updated the old server key to the new server key, with use of the new apparatus key.

A service utilization method in accordance with the embodiment of the claim 7 is used for receiving service from one or more server apparatuses, each providing service in response to a request made with use of an apparatus key that corresponds with a server key. The service utilization method comprises a key storing step of storing an old apparatus key and a new apparatus key, an acquiring step of acquiring update completion information indicating one or more, server apparatuses, each of which has completed key-updating by updating an old server key corresponding with the old apparatus key to a new server key corresponding with the new apparatus key, a judging step of making, with use of the update completion information, a comprehensive judgement on key-updating with respect to a group of at least one server apparatus, which provides service, a deleting step of deleting, if a result of the comprehensive judgement indicates that the group has completed the key-updating, the old apparatus key, and a utilizing step of receiving, if the result of the comprehensive judgement indicates that the group has completed the key-updating, service from, among the group, a server apparatus which has updated the old server key to the new server key, with use of the new apparatus key.

A service utilization program in accordance with the claim 8 is used for receiving service from one or more server apparatuses, each providing service in response to a request made with use of an apparatus key that corresponds with a server key. The utilization program comprises a key storing step of storing an old apparatus key and a new apparatus key, an acquiring step of acquiring update completion information indicating one or more server apparatuses, each of which has completed key-updating by updating an old server key corresponding with the old apparatus key to a new server key corresponding with the new apparatus key, a judging step of making, with use of the update completion information, a comprehensive judgement on key-updating with respect to a group of at least one server apparatus, which provides service, a deleting step of deleting, if a result of the comprehensive judgement indicates that the group has completed the key-updating, the old apparatus key, and a utilizing step of receiving, if the result of the comprehensive judgement indicates that the group has completed the key-updating, service from, among the group, a server apparatus which has updated the old server key to the new server key, with use of the new apparatus key.

An integrated circuit in accordance with the embodiment of the claim 9 is used by a utilization apparatus which receives service from one or more server apparatuses, each providing service in response to a request made with use of an apparatus key that corresponds with a server key. The integrated circuit comprises a key storage unit storing an old apparatus key and a new apparatus key, an acquisition unit operable to acquire update completion information indicating one or more server apparatuses, each of which has completed key-updating by updating an old server key corresponding with the old apparatus key to a new server key corresponding with the new apparatus key, a judgement unit operable to make, with use of the update completion information, a comprehensive judgement on key-updating with respect to a group of at least one server apparatus, from which the utilization apparatus receives service, a deletion unit operable to, if a result of the comprehensive judgement indicates that the group has completed the key-updating, delete the old apparatus key, and a utilization unit operable to, if the result of the comprehensive judgement indicates that the group has completed the key-updating, receive service from, among the group, a server apparatus which has updated the old server key to the new server key, with use of the new apparatus key.

With the stated structure, the old apparatus key can be deleted reliably upon updating of the server keys of one or more server apparatuses which provide service.

In addition, even when the server apparatuses which provide service include a server apparatus which has not completed the key-updating, the utilization apparatus is able to communicate with this server apparatus with use of the old apparatus key. Consequently, it is possible to avoid a situation where the utilization apparatus is unable to communicate with a server apparatus and thus is unable to receive service from the server apparatus.

A key utilization system 1 of the embodiment of the present invention is a certificate authority system using public key encryption.

The key utilization system 1 includes servers which provide services such as content transmission and the like and apparatuses including a key utilization apparatus which receives contents from the servers and plays back the received contents. The servers and the key utilization apparatus each hold a key of a designated version, which is used for performing communications and the like.

When the servers and the key utilization apparatus transmit/receive content to/from each other, the servers and the key utilization apparatus establish SAC (Secure Authenticated Channel) with use of the keys in order to prevent eavesdropping on the communicated data.

When establishing the SAC, the servers and the key utilization apparatus need to use keys of the same version. In regular operations, the keys coincide in their version.

Here, if the secret key of the root CA (Certificate Authority) is exposed, all of the keys held by the servers and the key utilization apparatus which are included in the certificate authority system are updated to ensure security.

Since the keys are not always updated concurrently, time lags occur in the updating of the keys, causing difference in version among the latest keys held by the apparatuses which communicate with each other.

However, under a predetermined condition, the servers and the key utilization apparatus of the present embodiment each hold both the pre-update key and the updated key. Thus, even when the version of the latest key held by each of the servers and the key utilization apparatus does not coincide with each other, the apparatuses establish the SAC and perform communications by choosing and using the keys of the same version.

In addition, a CRL transmitting apparatus generates a CRL (Certificate Revocation List) describing the identifiers of the servers which have updated their key and transmits the CRL to the servers and the key utilization apparatus regularly. The CRL is described in RFC3280 and the like.

The key utilization apparatus receives the CRL, checks whether the servers it connects to have updated their key or not, and deletes the pre-update key at appropriate timing.

With the above structure, the security level is maintained by deleting the pre-update key without using a secure clock.

In the following, the embodiment is described in detail using a specific example.

### 1. Structure of Key Utilization System

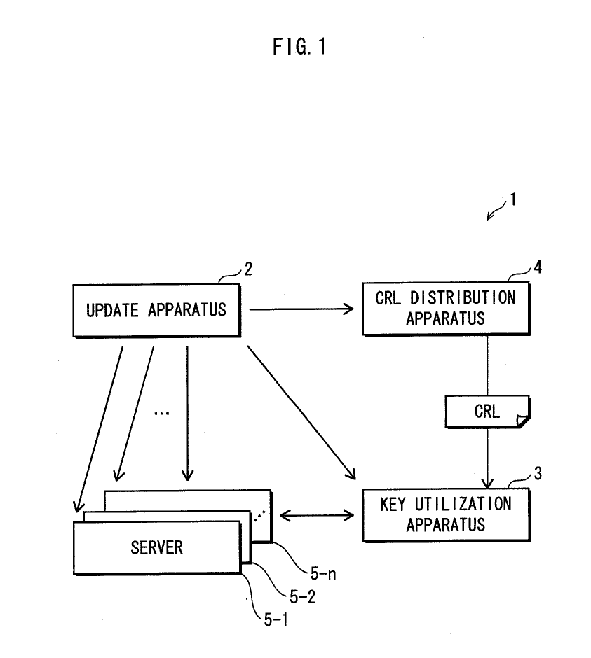

FIG. 1 shows a structure of the key utilization system 1 of a first embodiment.

The key utilization system 1 includes an update apparatus 2, a key utilization apparatus 3, a CRL distribution apparatus 4, and servers 5-1, 5-2, . . . , 5-n.

n denotes the number of servers connected to the key utilization apparatus 3, and, for example, is 5.

The servers 5-1, 5-2, . . . , 5-n are servers which provide service to the key utilization apparatus 3.

As an example, the server 5-1 transmits contents to the key utilization apparatus 3.

The servers 5-1, 5-2, . . . , 5-n each hold a server key used to perform communications, and update the server key upon receiving an update server key from the update apparatus 2.

The key utilization apparatus 3 receives contents from the servers and plays back the received contents.

The key utilization apparatus 3 holds an apparatus key used to perform communications, and updates the apparatus key upon receiving an update apparatus key from the update apparatus 2.

When the apparatus key and the server keys of the key utilization apparatus 3 and the servers 5-1, 5-2, 5-n need to be updated, the update apparatus 2 generates an update apparatus key and update server keys, and transmits these keys to the key utilization apparatus 3 and the servers 5-1, 5-2, . . . , 5-n.

The CRL distribution apparatus 4 generates a CRL which indicates whether the servers have updated the server keys and transmits the CRL to the key utilization apparatus 3 regularly.

Here, the key utilization system 1 uses a public key cryptography as an encryption method. The public key cryptography is, for example, an RSA crypto system, an elliptic curve cryptosystem or the like.

For the RSA cryptosystem and elliptic curve cryptosystem, refer to “Gendai Angou (Mondern Cryptography)” written by Tatsuaki Omamoto & Hiroshi Yamamoto and published by Sangyo Tosho, 1997, pp. 110-113 and pp. 120-121.

### 1.1 Structure of Update Apparatus 2

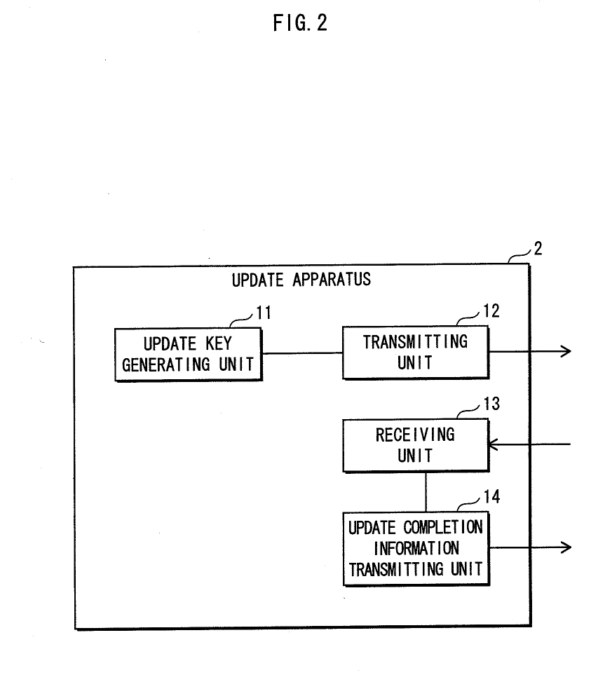

FIG. 2 is a block diagram showing the structure of the update apparatus 2.

The update apparatus 2 includes an update key generating unit 11, a transmitting unit 12, a receiving unit 13 and an update completion information transmitting unit 14.

The update key generating unit 11 generates update apparatus keys and update server keys.

The update apparatus key is a new apparatus key for updating the apparatus key which is being used by the key utilization apparatus 3.

The apparatus key includes a version of the apparatus key, and a secret key KSD, a public key certificate CD, and a root certificate CC of the key utilization apparatus 3.

The version is incremented every time the root certificate CC is updated.

The root certificate CC is a certificate of the root certificate authority which issues public key certificates. Specifically, CC is a concatenation of a public key KPC and signature data Sig (KSC, KPC) of the root certificate authority.

KSC is a secret key of the root certificate authority.

Here, “Sig (K,D)” indicates signature data generated from data D using a secret key K.

In the present embodiment, it is assumed that the signature data is generated based on the RSA signature scheme. However, another scheme such as an elliptic DSA signature scheme can be applied.

For the RSA signature scheme and the elliptic DSA signature scheme, refer to pp. 175-176 and pp. 182-183 of “Gendai Angou (Mondern Cryptography)”.

The public key certificate CD is a concatenation of the public key KPD of the key utilization apparatus 3, which corresponds to the secret key KSD, and the signature data Sig (KSC, KPD).

Additionally, the update server keys are new server keys for updating the server keys used by the servers 5-1, 5-2, . . . , 5-n, respectively.

The server key of a server 5-i (i denotes an integer from 1 to n) includes aversion of the server key, and a secret key KSS_i, a public key certificate CS_i, and the root certificate CC of the server.

The public key certificate CS_i is a concatenation of a public key KPS_i which corresponds to the secret key KSS_i of the server, and signature data Sig (KSC, KPS_i).

It should be noted that in the present embodiment, the update apparatus 2 itself serves as the root certificate authority and generates these apparatus key and server keys.

The transmitting unit 12 transmits the update apparatus key to the key utilization apparatus 3.

In addition, the transmitting unit 12 transmits update server keys, each corresponding with one of the servers 5-1, 5-2, . . . , 5-n, to the corresponding servers, respectively.

The receiving unit 13 receives, from the key utilization apparatus 3, update apparatus key request information which requests an update apparatus key and apparatus key update completion information which indicates completion of updating the apparatus key to the update apparatus key.

In addition, the receiving unit 13 receives update server key request information and server key update completion information which indicates completion of updating the server key to the update server key.

The update completion information transmitting unit 14 transmits the server key update completion information to the CRL distribution apparatus 4 upon receipt of the server key update completion information by the receiving unit 13.

### 1.2 Structure of Key Utilization Apparatus 3

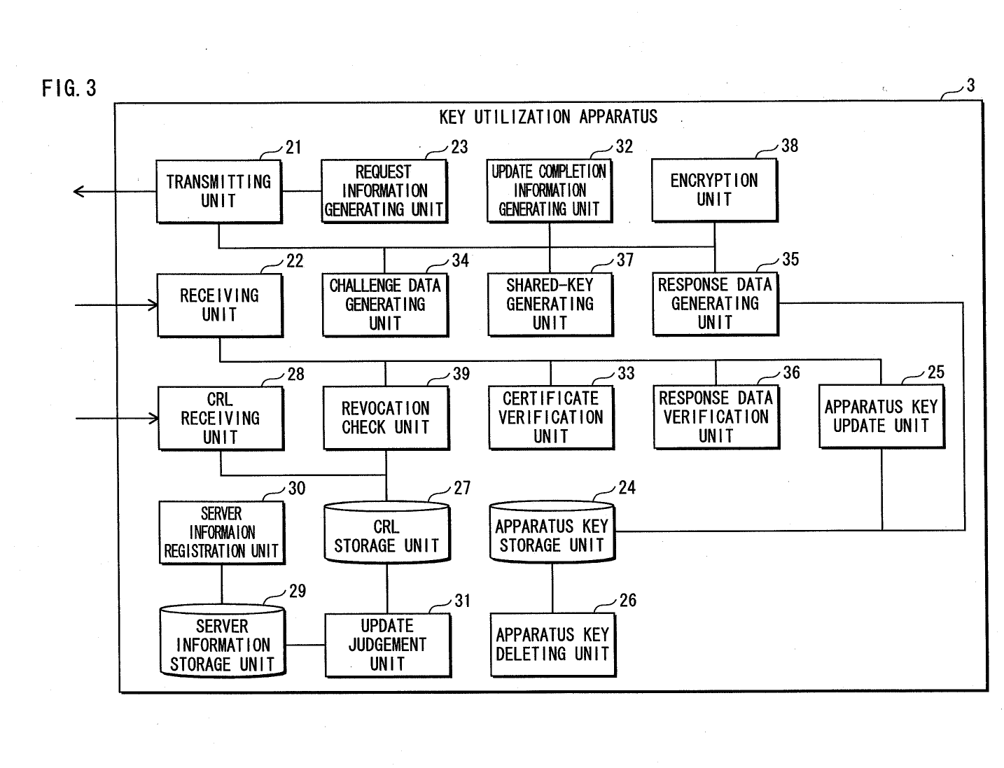

FIG. 3 is a block diagram showing the structure of the key utilization apparatus 3.

The key utilization apparatus 3 includes a transmitting unit 21, a receiving unit 22, a request information generating unit 23, an apparatus key storage unit 24, an apparatus key update unit 25, an apparatus key deleting unit 26, a CRL storage unit 27, a CRL receiving unit 28, a server information storage unit 29, a server information registration unit 30, an update judgement unit 31, an update completion information generating unit 32, a certificate verification unit 33, a challenge date generating unit 34, a response data generating unit 35, a response data verification unit 36, a shared-key generating unit 37, an encryption unit 38, and a revocation check unit 39.

The transmitting unit 21 transmits various data to the update apparatus 2 and the servers 5-1, 5-2, . . . , 5-n based on requests from other processing units.

The receiving unit 22 receives the update apparatus key transmitted from the update apparatus 2.

The request information generating unit 23 generates the update apparatus key request information.

The update apparatus key request information includes information on the key utilization apparatus 3 and information indicating the request.

More specifically, the update apparatus key request information includes the identifier of the key utilization apparatus 3 and a character string “Request”.

The apparatus key storage unit 24 stores the apparatus key and a current apparatus key version which is the version of the apparatus key being currently used.

The apparatus key update unit 25 stores in the apparatus key storage unit 24 the update apparatus key received from the receiving unit 22 and increments the current apparatus key version.

For example, if the version before update is “0”, the incremented version after update is “1”.

The apparatus key deleting unit 26, if a judgement result by the update judgement unit 31 indicates that each of the connection servers has updated the key thereof, deletes the pre-update apparatus key which is stored in the apparatus key storage unit 24.

Specifically, the apparatus key deleting unit 26 deletes, among apparatus keys stored in the apparatus key storage unit 24, the apparatus keys whose version is smaller than the current apparatus key version.

The CRL storage unit 27 stores therein server key revocation information (hereinafter, referred to as “CRL”).

The CRL indicates revocation status of the pre-update server keys of the servers 5-1, 5-2, . . . , 5-n.

The CRL, for example, is composed of data including the identifier of the server whose pre-update server key has been revoked, and the signature of the CRL-distribution apparatus 4.

One example of the identifier of the server is a concatenation of “S”, which denotes server, and the suffix number “i” of the server 5-i. The identifier of the server 5-1, for example, is “S1”.

The CRL receiving unit 28 receives the CRL from the CRL distribution apparatus 4 and stores the received CRL in the CRL storage unit 27.

While, basically, the CRL is received regularly, it can be received irregularly as well.

The server information storage unit 29 stores therein connection server information.

The connection server information indicates connection servers used by the key utilization apparatus 3.

The server information registration unit 30 registers the connection servers used by the key utilization apparatus 3 in the connection server information and stores the connection server information in the server information storage unit 29.

A connection server is registered in the connection server information when the key utilization apparatus 3 accesses the connection server for the first time.

Specifically, during encrypted communication with the servers 5-1, 5-2, . . . , 5-n, the server information registration unit 30 checks whether the identifier of the server with which the server information registration unit 30 is communicating with has been registered in the connection server information. If the identifier has not been registered, the server information registration unit 30 registers the identifier in the connection server information and stores the connection server information in the server information storage unit 29.

The update judgement unit 31, (i) when the identifiers of all the servers described in the connection server information are included in the CRL, outputs a judgement result indicating that all the connection server shave updated their respective server keys, and (ii) when otherwise, outputs a judgement result indicating that the server keys have not been updated.

Here, when the keys have not been updated, information such as the identifier of each server which has not updated its server key may be output.

The update information generating unit 32 generates the apparatus key update completion information.

The apparatus key update completion information includes information on the key utilization apparatus and information indicating completion of the update.

More specifically, the apparatus key update completion information includes the identifier of the key utilization apparatus 3 and a character string “Updated”.

The certificate verification unit 33 verifies the server public key certificate CS_i received from the server 5-i (i denotes an integer from 1 to n) with use of the root public key included in the apparatus key which is stored in the apparatus key storage unit 24 and whose version matches the version included in the CS_i.

The challenge data generating unit 34 generates challenge data ND which is a random number.

The response data generating unit 35 generates response data RD_i in response to the challenge data NS_i received from the server 5-i with use of the apparatus key which is stored in the apparatus key storage unit 24 and whose version matches the current apparatus key version stored in the apparatus key storage unit 24.

Here, RD_i=Sig (KSD, NS_i).

Additionally, KSD is an apparatus secret key included in the apparatus key.

The response data verification unit 36 verifies the response data RS_i received from the server 5-i with use of the server public key included in the server public key certificate which has been received from the server 5-i as well.

The shared-key generating unit 37 generates a shared key AK which is a random number.

Here, the shared key is a shared key used in a symmetric-key cryptography.

For example, if the symmetric-key cryptography is AES encryption and key length is 128 bits, key length of the shard key is also 128 bits.

It should be noted that the symmetric-key cryptography is not limited to the AES encryption and may be DES encryption or triple DES encryption. Likewise, instead of the shared key, shared secret information may be generated.

The encryption unit 38 generates an encrypted shared key EK by encrypting the shared key AK with use of the server public key which is included in the server public key certificate CS_i received from the server 5-i.

Here, EK is expressed as PEnc (KPS_i, AK).

The description “PEnc (K,D)” indicates an encrypted text which is generated by encrypting the data D with the public key K.

Additionally, KPS_i is a server public key.

The revocation check unit 39 checks whether or not the CRL stored in the CRL storage unit 27 includes information on the server 5-i.

If the CRL includes the information on the server 5-i, the server 5-i is determined to have been revoked.

### 1.3 Structure of CRL Distribution Apparatus 4

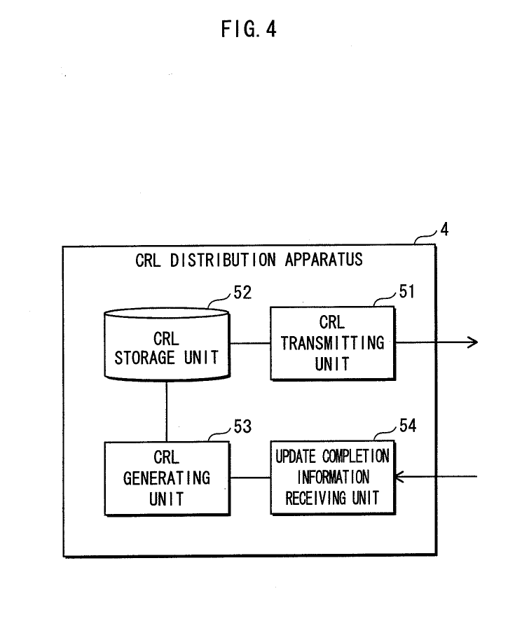

FIG. 4 shows the structure of the CRL distribution apparatus 4.

The CRL distribution apparatus 4 includes a CRL transmitting unit 51, a CRL storage unit 52, a CRL generating unit 53, and an update completion information receiving unit 54.

The CRL transmitting unit 51 transmits the CRL generated by the CRL generating unit 53 to the key utilization apparatus 3.

The CRL storage unit 52 stores the CRL.

The update completion information receiving unit 54 receives the server key update completion information from the update apparatus 2.

The CRL generating unit 53 updates the CRL stored in the CRL storage unit using the server key update completion information received from the update completion information receiving unit 54.

Specifically, the CRL generating unit 53 performs the updating by adding the identifier of each server included in the server key update completion information to the server key revocation information CRL. Following that, the CRL generating unit 53 generates a new signature of the CRL distribution apparatus 4 and replaces the signature currently attached to the CRL with the new signature.

Note that the CRL initially is data which includes information indicating that there is no sever key revoked, and a signature, by the root certificate authority, attached thereto.

The above-mentioned information indicating that there is no server key revoked is, for example, “0”.

### 1.4 Structure of Servers 5-1 to 5-n

Since the servers 5-1 to 5-n each have an identical structure, description is given on the structure of 5-i in the following.

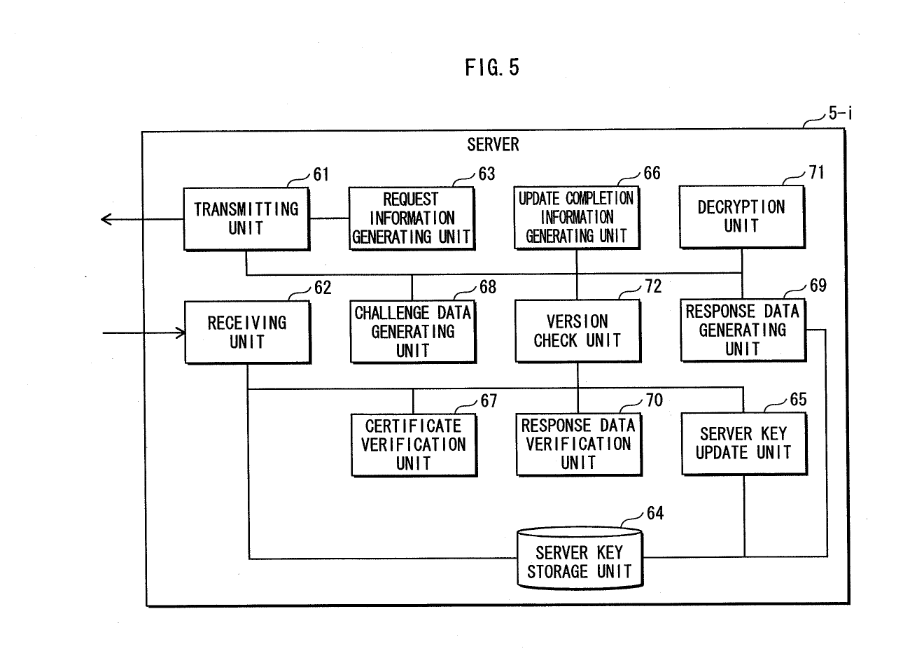

FIG. 5 shows the structure of the server 5-i.

The server 5-i includes a transmitting unit 61, a receiving unit 62, an update server key request information generating unit 63, a server key storage unit 64, a server key update unit 65, an update completion information generating unit 66, a certificate verification unit 67, a challenge data generating unit 68, a response data generating unit 69, a response data verification unit 70, a decryption unit 71, and a version check unit 72.

The transmitting unit 61 transmits data to the update apparatus 2 and the key utilization apparatus 3.

The receiving unit 62 receives data transmitted by the update apparatus 2 and the key utilization apparatus 3.

The request information generating unit 63 generates the update server key request information.

The update server key request information is information used to request update of the server key, and includes information on the server 5-i and information indicating the request.

More specifically, the update server key request information includes the identifier of the server 5-i and the character string “Request”.

The server key storage unit 64 stores the server key and a current server key version which is the version of the server key being currently used.

The server key update unit 65 stores in the server key storage unit 64 the update server key received by the receiving unit 62 and updates the current server key version to the version of the update server key.

The update completion information generating unit 66 generates the server key update completion information upon completion of updating the server key by the server key update unit 65.

The server key update completion information includes, for example, information on the server 5-i, which is the identifier, and character information “Complete” which indicates completion of the update.

The certificate verification unit 67 verifies the apparatus public key certificate received from the key utilization apparatus 3, with use of the root public key included in the server key which is stored in the server key storage unit 64 and whose version matches the version included in the apparatus public key certificate.

The challenge data generating unit 68 generates the challenge data NS_i which is a random number.

The response data generating unit 69 generates the response data RS_i in response to the challenge data ND received from the key utilization unit with use of the server key whose version matches the current server key version.

Here, RS_i Sig (KSS_i, ND).

It should be noted that KSS_i is a server secret key included in the server key.

The response data verification unit 70 verifies the response data RD_i received from the key utilization apparatus 3 with use of the apparatus public key included in the apparatus public key certificate which has been received from the key utilization apparatus 3 as well.

The decryption unit 71 generates a decrypted shared key AK′ by decrypting the encrypted shared key EK received from the key utilization apparatus 3 with use of the server secret key included in the server key. If the decryption is performed properly, the shared key AK and the decrypted shared key AK′ match each other.

The version check unit 72 checks the current apparatus key version received from the key utilization apparatus 3.

If the current server key version is the current apparatus key version or greater, the version check unit 72 instructs the transmitting unit 61 to transmit the server public key certificate included in the server key whose version matches the current apparatus key version. If the current server key version is smaller than the current apparatus key version, the version check unit 72 instructs the transmitting unit 61 to transmit the server public key certificate included in the server key whose version matches the current server key version.

### 2. Operations of Key Utilization System 1

Operations of the key utilization system 1 mainly include the following 4 processes: (1) apparatus key update processing which updates the apparatus key of the key utilization apparatus; this processing is executed by the update apparatus 2 and the key utilization unit 3; (2) server key update processing which updates the server keys of the server 5-i; this processing is executed by the CRL distribution apparatus 4 and the server 5-i; (3) CRL distribution processing which distributes CRL; this processing is executed by the key utilization apparatus 3 and the server 5-i; and (4) key utilization processing (certification processing) which utilizes keys; this processing is executed by the key utilization apparatus 3 and the server 5-i. After the certification processing, the key utilization apparatus performs such as playback of the contents received from the server. However, this processing is known, and thus, description is omitted.

The above 4 processing are described in sequence in the following.

### 2.1 Apparatus Key Update Processing

In the apparatus key update processing, the key utilization apparatus 3 requests the update apparatus 2 to send an update apparatus key and updates the apparatus key of its own using the update apparatus key received, in response to the request, from the update apparatus 2.

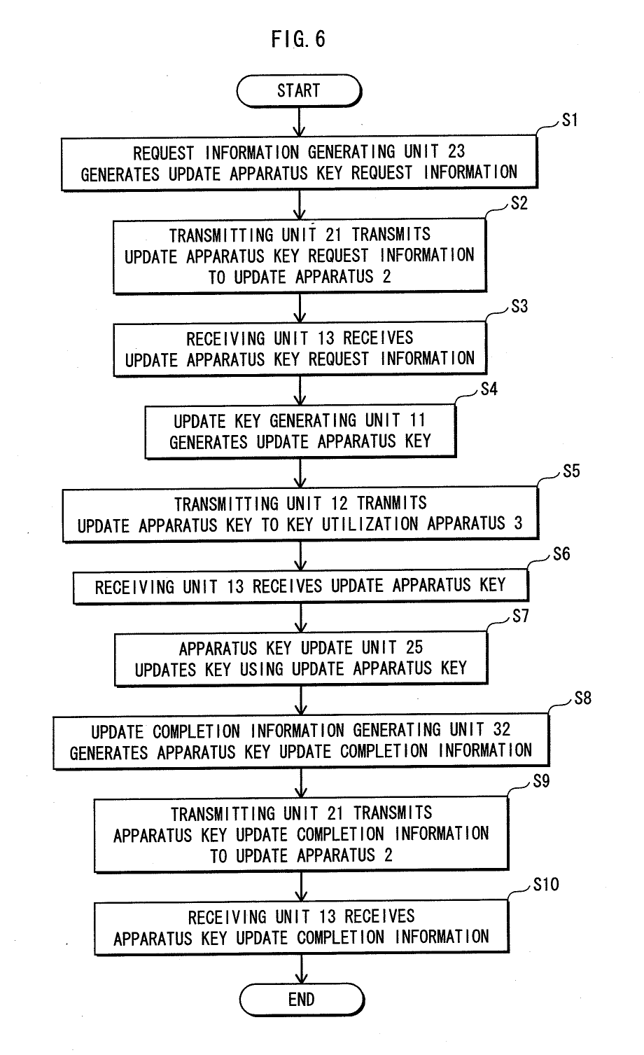

In the following, the apparatus key update processing is described referring to FIG. 6.

FIG. 6 is a flowchart showing the operation of the apparatus key update processing.

First, in the key utilization apparatus 3, the request information generating unit 23 generates update apparatus key request information (step S1) and transmits the generated update apparatus key request information to the update apparatus 2 via the transmitting unit 21 (step S2).

The generation of the update apparatus key request information by the request information generation unit 23 may be triggered by reception, by the key utilization apparatus 3, of a notification of an apparatus key update, from the root CA. For example, when it has become apparent to the root CA that the secret key of the root CA is exposed, the root CA transmits the notification of an apparatus key update, as mentioned above, to the key utilization apparatus 3.

The receiving unit 13 of the update apparatus 2 receives the update apparatus key request information (step S3).

After that, triggered by the reception of the update apparatus key request information, the update key generating unit 11 generates the update apparatus key for the key utilization apparatus 3 (step S4).

The transmitting unit 12 transmits the update apparatus key to the key utilization apparatus 3 (step S5).

The receiving unit 13 of the key utilization apparatus 3 receives the update apparatus key (step S6).

Following that, the apparatus key update unit 25 updates the apparatus key of the key utilization apparatus 3 using the update apparatus key (step S7).

Upon completion of the apparatus key update, the update information generating unit 32 generates apparatus key update completion information (step S8) and transmits the generated apparatus key update completion information to the update apparatus 2 via the transmitting unit 21 (step S9).

The receiving unit 13 of the update apparatus 2 receives the apparatus key update completion information (step S10) and the apparatus key update processing is completed.

### 2.2 Server Key Update Processing

In the server key update processing, the servers 5-1 to 5-n each request an update server key from the update apparatus 2 and update the server key of its own using the update server key received, in a response to the request, from the update apparatus 2.

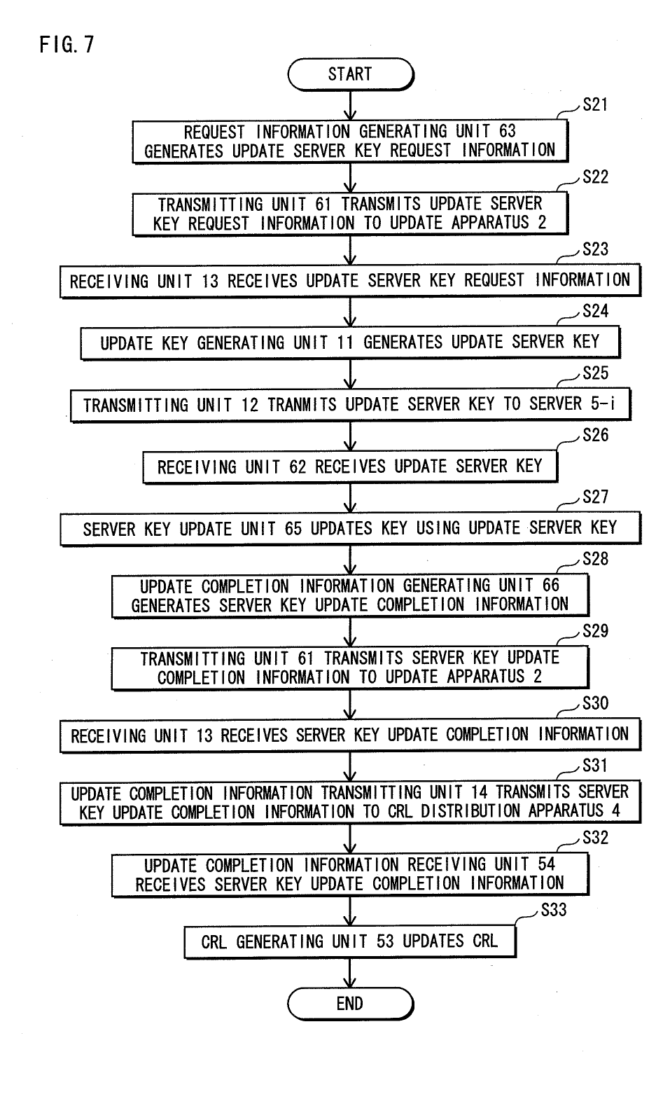

In the following, the server key update processing is described referring to FIG. 7.

It should be noted that since the operation of the server key update processing is the same among the servers 5-1 to 5-n, description is given on the operation on the server 5-i.

FIG. 7 is a flowchart showing the operation of the server key update processing.

First, the request information generating unit 63 of the server 5-i generates update server key request information (step S21) and transmits the generated update server key request information to the update apparatus 2 via the transmitting unit 61 (step S22).

The generation of the update server key request information by the request information generating unit 63 may be triggered by the reception, by the server 5-i, of a notification of a necessity of updating the server key, from the root CA.

For example, when it has become apparent to the root CA that the secret key of the root CA is exposed, the root CA transmits a notification of a server key update being required, as mentioned above, to the server 5-i.

The receiving unit 13 of the update apparatus 2 receives the update server key request information (step S23).

Triggered by the reception of the update server key request information, the update key generating unit 11 generates an update server key (step S24) and transmits the generated update server key to the server 5-i via the transmitting unit 12 (step S25).

The receiving unit 62 of the server 5-i receives the update server key (step S26).

The server key update unit 65 updates the server key using the update server key (step S27).

Triggered by the update of the server key, the update information generating unit 66 generates server key update completion information (step S28) and transmits the generated server key update completion information to the update apparatus 2 via the transmitting unit 61 (step S29).

The receiving unit 13 of the update apparatus 2 receives the server key update completion information (step S30).

The update completion information transmitting unit 14 transmits a received CRL to the CRL distribution apparatus 4 (step S31).

The receiving unit 54 of the CRL distribution apparatus 4 receives the server key update completion information (step S32).

The CRL generating unit 53 updates the CRL using the received CRL (step S33), and the server key update processing is completed.

### 2.3 CRL Distribution Processing

In the CRL distribution processing, the CRL distribution apparatus 4 distributes a CRL to the key utilization apparatus 3.

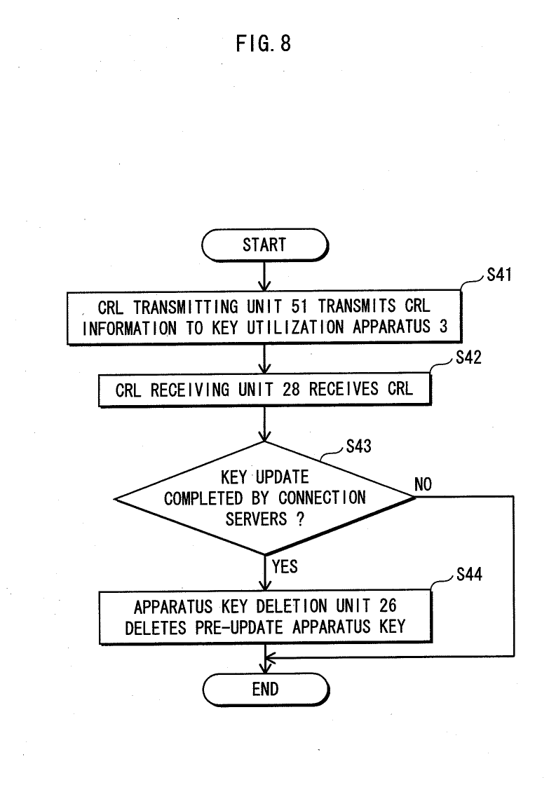

In the following, the CRL distribution processing is described referring to FIG. 8.

FIG. 8 is a flowchart showing the operation of the CRL distribution processing.

The CRL transmitting unit 51 of the CRL distribution apparatus 4 transmits a CRL to the key utilization apparatus 3 (step S41).

This transmission is, for example, triggered by a CRL update by the CRL generating unit 53.

The CRL receiving unit 28 of the key utilization apparatus 3 receives the CRL (step S42).

The update judgment unit 31 makes a judgement whether the connection servers have completed key-updating or not by referring to the CRL (step S43).

If the judgement is negative in the step S43 (step S43: No), the CRL distribution processing is completed.

If the judgement is affirmative (step S43: Yes), the apparatus key deleting unit 26 deletes the pre-update apparatus key (step S44), and the CRL distribution processing is completed.

### 2.4 Key Utilization Processing

In the key utilization processing, an authentication and the like are executed by the key utilization apparatus 3 and the servers 5-1 to 5-n using keys.

The key utilization processing is mainly composed of processing in which the key utilization apparatus 3, when accessing a server for the first time, generates connection server information.

This processing is described in the following.

It should be noted that the operation of the key utilization apparatus 3 is the same regardless of on which of the servers 5-1 to 5-n the operation is performed. Accordingly; as an example, description is given on the operation performed with the server 5-i.

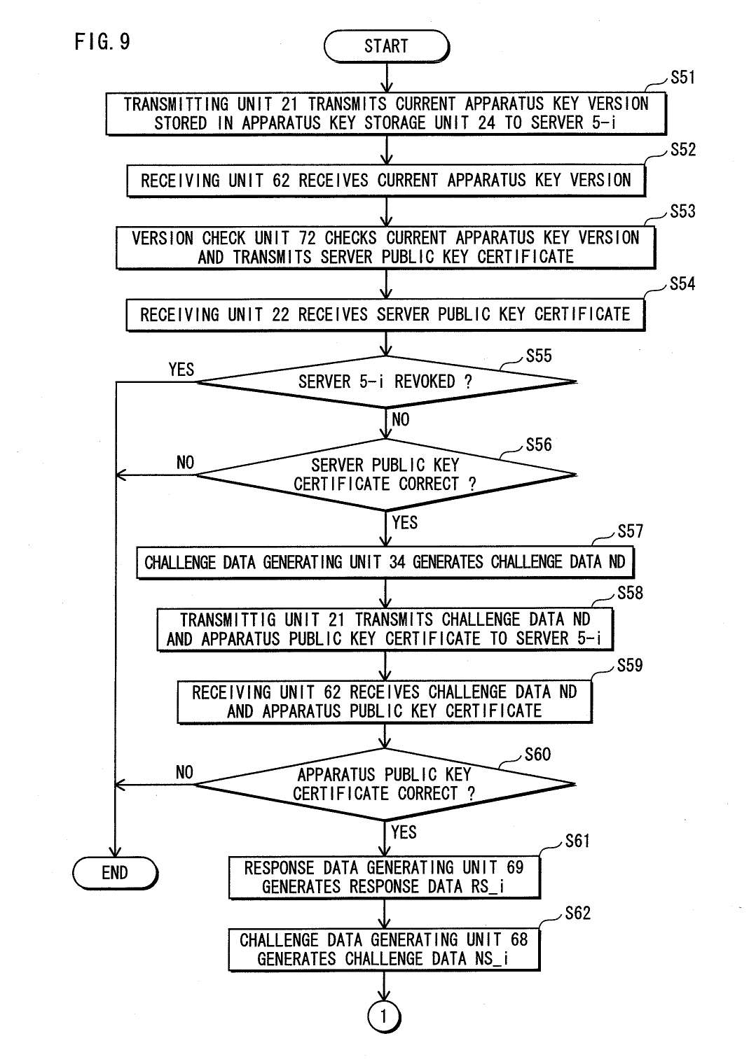

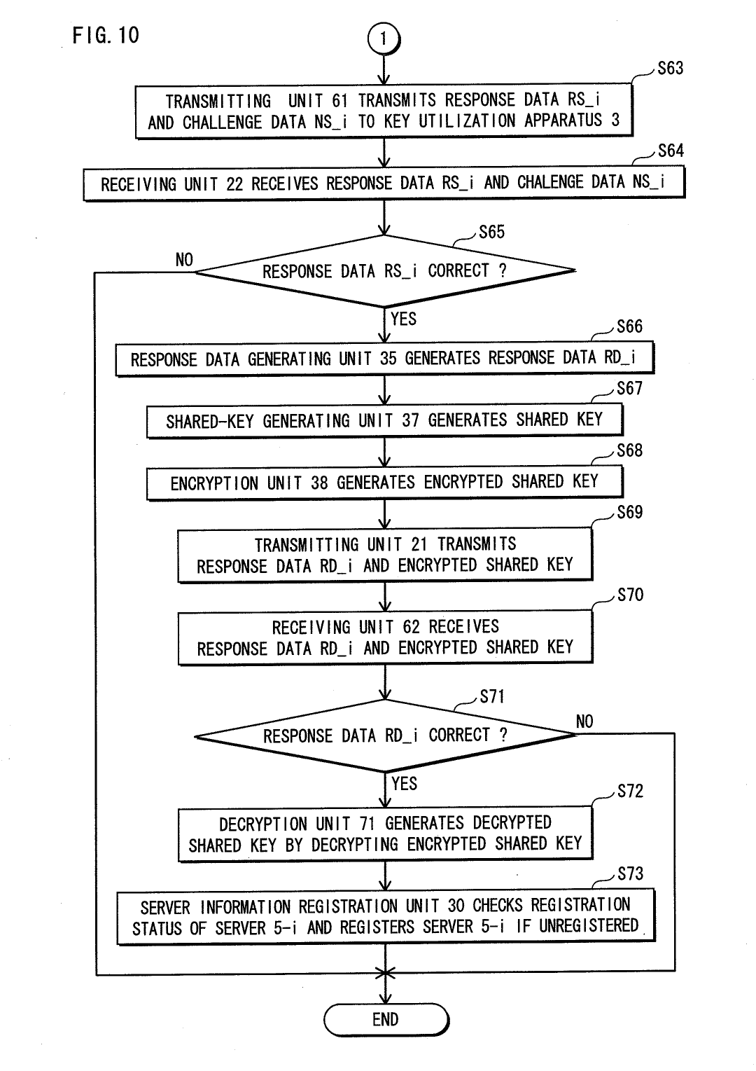

FIGS. 9 and 10 are a flowchart showing the first half of the key utilization processing.

The transmitting unit 21 of the key utilization apparatus 3 transmits the current apparatus key version stored in the apparatus key storage unit 24 to the server 5-i (step S51).

The receiving unit 62 of the server 5-i receives the current apparatus key version (step S52).

The version check unit 72 checks the current apparatus key version (step S53) and, if the current server key version is equal to or greater than the current apparatus key version, transmits the server public key certificate included in the server key whose version is equivalent to the current apparatus key version to the key utilization apparatus 3 via the transmitting unit 61.

If the current server key version is smaller than the current apparatus key version, the version check unit 72 transmits the server public key certificate included in the server key whose version is equivalent to the current server key version to the key utilization apparatus 3 via the transmitting unit 61.

The receiving unit 22 of the key utilization apparatus 3 receives the server public key certificate (step S54).

After that, the revocation check unit 39 refers to the CRL and judges whether the server 5-i has been revoked or not (step S55), and if the server 5-i is judged to have been revoked (step S55: Yes), the key utilization processing terminates.

If the server 5-i is judged not to have been revoked (step S55: No), the certificate verification unit 33 verifies the public key certificate (step S56).

If the server public key certificate is incorrect (step S56: No), the key utilization processing terminates.

If the server public key certificate is correct (step S56: Yes), the challenge date generating unit 34 generates challenge data ND (step S57).

Following that, the transmitting unit 21 transmits, to the server 5-i, the challenge data ND and the apparatus public key certificate whose version is the same as the version included in the server public key certificate (step S58).

The receiving unit 62 of the server 5-i receives the challenge data ND and the apparatus public key certificate (step S59).

The certificate verification unit 67 verifies the apparatus public key certificate (step S60), and if the apparatus public key certificate is incorrect (step S60: No), the key utilization processing terminates.

If the apparatus public key certificate is correct (step S60: Yes), the response data generating unit 69 generates the response data RS_i (step S61).

After that, the challenge data generating unit 68 generates challenge data NS_i (step S62).

The transmitting unit 61 then transmits the response data RS_i and the challenge data NS_i to the key utilization apparatus 3 (step S63).

The receiving unit 22 of the key utilization apparatus 3 receives the response data RS_i and the challenge data NS_i (step S64).

The response data verification unit 36 verifies the response data RS_i (step S65), and if the response data RS_i is incorrect (step S65: No), the key utilization processing terminates.

If the response data RS_i is correct (step S65: Yes), the response data generating unit 35 generates the response data RD_i (step S66).

The shared-key generating unit 37 generates a shared key (steps S67).

The encryption unit 38 generates the encrypted shared key (step S68).

The transmitting unit 21 transmits the response data RD_i and the encrypted shared key (step S69).

The receiving unit 62 of the server 5-i receives the response data RD_i and the encrypted shared key (step S70).

Following that, the response data verification unit 70 verifies the response data RD_i (step S71), and if the response data RD_i is incorrect (step S71: No), the key utilization processing terminates.

If the response data RD_i is correct (step S71: Yes), the decryption unit 71 decrypts the encrypted shard key so as to generate the decrypted shared key (step S72).

The server information registration unit 30 checks whether or not the identifier of the server 5-i is registered in the connection server information, and if the identifier is not registered, registers the identifier in the connection server information and stores the connection server information in the server information storage unit 29 (step S73).

The above is the description of the key utilization processing.

### 3. Advantages of the Key Utilization System 1

As described above, according to the first embodiment, the key utilization apparatus refers to the CRL and deletes the pre-update apparatus key upon finding out the revocation of the connection servers which the key utilization apparatus uses.

Accordingly, the key utilization apparatus can control the deletion of the pre-update key without a secure clock.

In addition, since the pre-update key of the key utilization apparatus is deleted after the server keys of the connection servers are updated, encrypted communication can be performed using the pre-update key even during the process of updating the server keys of the connection servers.

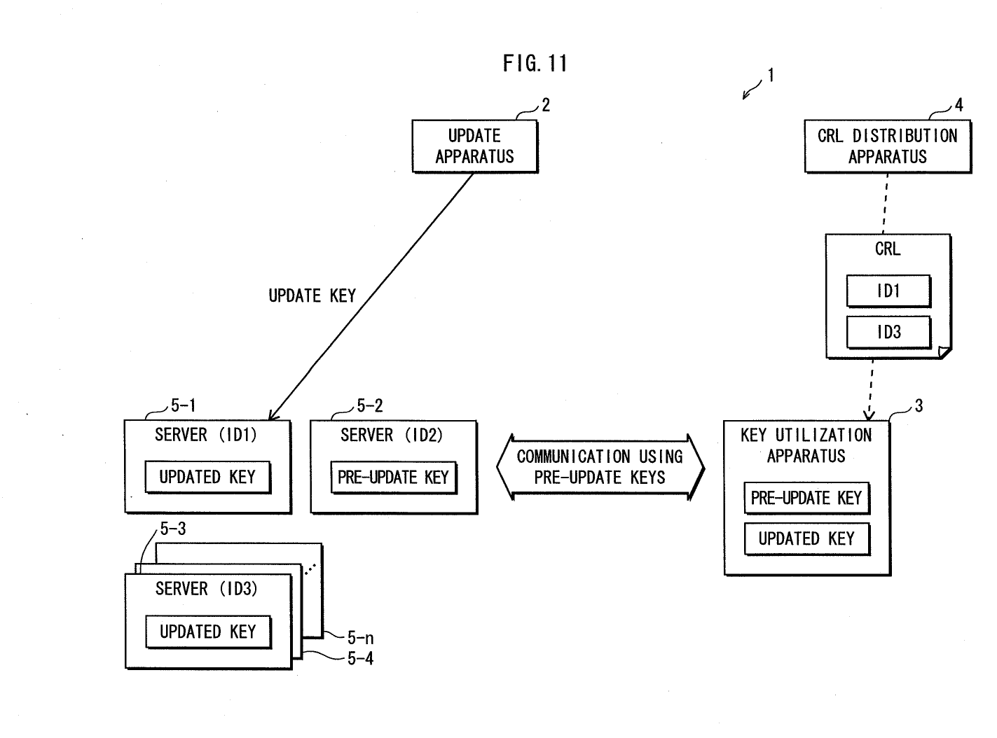

The following provides more detailed description with reference to FIG. 11.

FIG. 11 schematically shows the key utilization system 1 before the server key of the server 5-2 is updated.

The server 5-1 which the key utilization apparatus 3 connects to has completed the key update, thus holding the updated key.

The server 5-2 which the key utilization apparatus 3 connects to has not updated the key, thus still holding the pre-update key.

The server 5-3 which the key utilization apparatus 3 does not connect to has completed updating the key, thus holding the updated key.

In this case, the CRL transmitted from the CRL distribution apparatus 4 to the key utilization apparatus 3 includes the identifiers (ID1, ID3) of the servers 5-1 and 5-3 which have completed the key update.

The key utilization apparatus 3, by referring to the CRL, recognizes that the server 5-1 has updated the key and the server 5-2 has not update the key.

Not finding the identifiers of the connection servers 5-1 and 5-2 in the CRL, the key utilization apparatus 3 does not delete the pre-update key, but keeps holding it instead.

Accordingly, the key utilization apparatus 3 performs encrypted communication with the server 5-1 using the updated key while performing communication with the server 5-2 using the pre-update key.

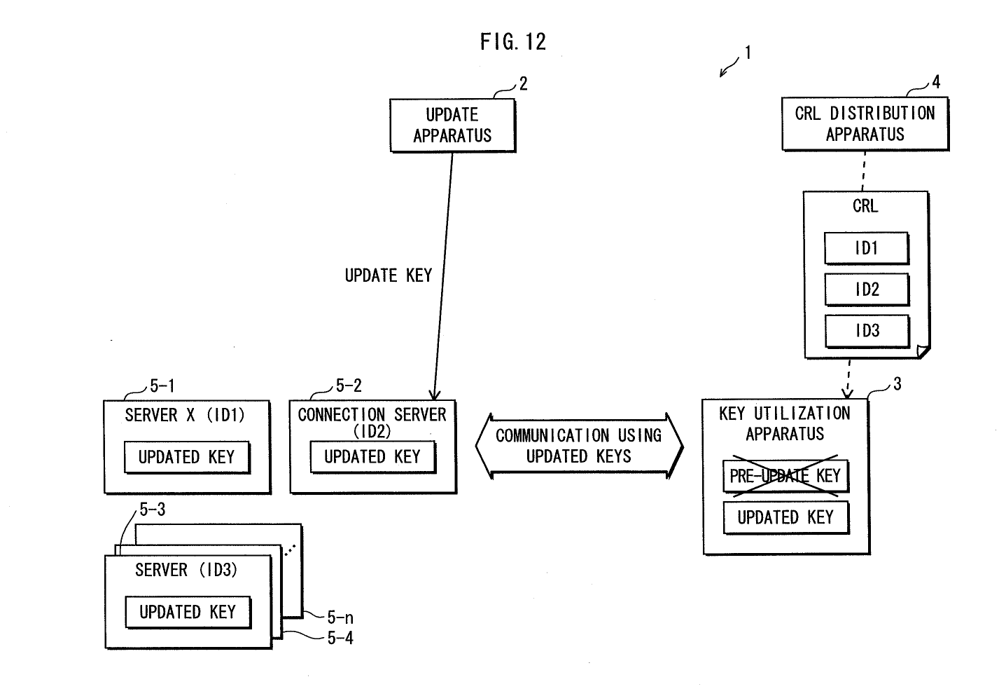

FIG. 12 schematically shows the key utilization system 1 after the server key of the server 5-2 is updated.

The server 5-2 has updated the key and holds the updated key.

In this case, the CRL transmitted from the CRL distribution apparatus 4 to the key utilization apparatus 3 includes the identifiers (ID2, ID2, and ID3) of the servers 5-1, 5-2, and 5-3 which have completed the key update.

The key utilization apparatus 3, by referring to the CRL, recognizes that the servers 5-1 and 5-2 have completed the key update.

Having found the identifiers of all the connection servers, which are 5-1 and 5-2, in the CRL, the key utilization apparatus 3 deletes the pre-update key and holds only the update key.

Accordingly, the key utilization apparatus 3 performs encrypted communication with the servers 5-1 and 5-2 using the updated key.

As described above, irrespective of whether the keys of the connection servers are in the process of being updated as shown in FIG. 11, or the keys of all the connection servers have been updated as shown in FIG. 12, the key utilization apparatus and the connection servers can perform encrypted communication.

### 4. Modification

Although the present invention has been described by way of the embodiment above, it is to be noted that the present invention is not limited to the embodiment, and naturally, various modifications should be construed as being included therein unless such modifications depart from the scope of the present invention. For examples, the following cases are included in the present invention as well.

(1) In the above-mentioned embodiment, the update apparatus 2 serves as the root certificate authority. However, a root certificate authority which generates apparatus keys and server keys can be provided separately from the update apparatus 2. In this case, the update apparatus 2, instead of generating update keys, acquires the update keys from the root certificate authority and stores these keys therein.

In addition, a key generating apparatus and a key generating agency which generate only pairs of secret key and public key may be provided separately from a certificate issuing apparatus and a certificate issuing agency which issue certificates.

(2) In the above-described embodiment, the update completion information transmitting unit 14 transmits the server key update completion information to the CRL distribution apparatus 4 upon the reception of the server key update completion information by the receiving unit 13. However, instead of transmitting promptly upon the reception, the receiving unit 13 can accumulate the server update completion information and transmit regularly or upon receiving a transmission request from the CRL distribution apparatus 4.

Additionally, the server key update completion information received by the transmitting unit 13 can be processed such as to include therein only the identifiers of the updated servers before being transmitted.

(3) In the above-described embodiment, a server is registered in connection server information when the key utilization apparatus 3 accesses the server for the first time. However, the key utilization apparatus 3 can receive input of the identifier of a server by the user and register the input identifier of the server in the connection server information.

In addition, the connection server information can be managed by another apparatus which manages server connections, and can be acquired by the server information registration unit 30 and stored in the server information storage unit 29.

(4) While in the above-described embodiment, the CRL distribution processing is basically performed on a regular basis, it can be performed irregularly.

Also, while the operation of the CRL distribution processing is triggered by a transmission of a CRL from the CRL distribution apparatus 4, the key utilization apparatus 3 can transmit a server key revocation information distribution request to the CRL distribution apparatus 4, and this transmission can be used as the trigger.

(5) In the above-described embodiment, signature data of a public key serves as a certificate. However, target data of the signature data can be not only the public key, but also include holder information of the public key such as the ID of the public key. In this case, the certificate includes the holder information of the public key.

(6) In the above-described embodiment, a CRL includes a signature by the CRL distribution apparatus. However, a signature by an apparatus or an agency other than the CRL distribution apparatus can be included. Additionally, while the update apparatus serves as the root certificate authority, a root certificate authority other than the update apparatus can be provided and the CRL can include a signature by this root certificate authority.

(7) In the above-described embodiment, the key utilization apparatus deletes the pre-update apparatus key upon judging, using the CRL, that all the pre-update server keys of the connections servers have been revoked. However, this is not limited to this.

For example, the pre-update apparatus key can be deleted when the majority or ⅓ of the pre-update server keys of the connection servers have been revoked.

Further, the pre-update apparatus key can be deleted in a case where servers which the key utilization apparatus 3 frequently accesses are revoked, or servers which the key utilization apparatus accesses recently are revoked. Or, the key utilization apparatus can include a clock and delete, from the connection server information, information on the servers which the key utilization apparatus has not accessed for a predetermined period (for example, for the last one month).

(8) In the above-described embodiment, version is used as the information. However, it is not limited to this, and information indicating the number of updates can be employed.

(9) A CRL can include information indicating a version which is the same as (or changes in conjunction with) the version of the apparatus key and the server keys. In this case, the update judgement unit 31 judges, using the CRL, whether or not the server keys which have the same version as the CRL have been updated.

Further, upon deleting the pre-update apparatus key, the key utilization apparatus 3 can stop receiving the CRL which has the version same as the version of the deleted apparatus key.

(10) In the above-described embodiment, as examples of use of the apparatus key, the certificate verification unit which verifies the server public keys uses the root certificate included in the apparatus key, and the response data generating unit uses the apparatus secret key included in the apparatus key. However, the use of the apparatus is not limited to the examples above, and for example, can be used to decrypt public key encryption.

In this case, encrypted texts are decrypted using the apparatus secret key.

(11) The update apparatus, before transmitting an update apparatus key, can add handling information of the pre-update apparatus key to the update apparatus key. The handling information may indicate that the pre-update apparatus key is to be deleted upon acquisition of information which states that all the connection servers have updated the pre-update server keys, respectively. In this case, the key utilization apparatus deletes the pre-update apparatus key in accordance with the handling information. Additionally, the handling information may indicate conditions under which the pre-update apparatus is deleted. For example, the conditions may indicate a case where the majority of the connection servers have completed the key update, or a case where a certain number of the connection servers have completed the key update.

(12) The key utilization apparatus may store encrypted contents which are encrypted with use of the apparatus key, keys for encrypting contents, and encrypted data of secret information, and the pre-update apparatus key may be deleted upon completion of re-encryption of these data with the update apparatus key.

In addition, the pre-update apparatus key may be deleted upon judging that the re-encrypted data can be acquired from other apparatuses or agencies.

Further, these conditions for deleting the pre-update apparatus key may be used as the handling information.

(13) The CRL distribution apparatus may detect the beginning of the use of the update server key by the server and transmits the detected result as the server key update information, instead of the CRL, to the key utilization apparatus. In this case, the key utilization apparatus uses the server key update information to judge whether or not the pre-update apparatus key is to be deleted.

(14) As is the case with the key utilization apparatus, the servers may delete the pre-update server keys based on the revocation status or key-update status of the apparatus key.

(15) In the above-described embodiment, the apparatus key is used for encrypted communication between the servers and the key utilization apparatus. However, the apparatus key may be used for encrypted communication between multiple key utilization apparatuses.

(16) In the above-described embodiment, the signature data Sig (KSC, KPC) with KPC being the signature target is used as CC. However, the signature target data is not limited to KPC and can be other data. For instance, the signature target data can be a concatenation of KPC and the version.

As is the case with CC, the signature target data of the signature data Sig (KSC, KPD) which is used as CD, is not limited to KPD and can be other data. For instance, the signature target data can be a concatenation of KPD and the version.

(17) Each of the above-mentioned apparatuses, specifically, is a computer system including a microprocessor, a ROM, a RAM, a hard disk unit, a display unit, a keyboard, a mouse, and the like. Computer programs are stored in the ROM, RAM, or hard disk unit, and each apparatus achieves its predetermined functions as the microprocessor operates in accordance with the computer programs. Here, each computer program is composed of a plurality of command codes that show instructions with respects to the computer, for achieving the predetermined functions.

(18) All or part of the compositional elements of each apparatus may be composed from one system LSI (Large Scale Integration). The system LSI is a super-multifunctional LSI on which a plurality of compositional units are manufactured integrated on one chip, and is specifically a computer system that includes a microprocessor, a ROM, a RAM, or the like. Computer programs are stored in the RAM. The LSI achieves its functions by the microprocessor operating according to the computer programs.

(19) Part or all of the compositional elements of each apparatus may be composed of a removable IC card or a single module. The IC card or the module is a computer system composed of a microprocessor, a ROM, a RAM, or the like. The IC card or the module may include the aforementioned super-multifunctional LSI. The IC card or the module may achieve its functions by the microprocessor operating according to computer programs. The IC card or the module may be tamper-resistant.

(20) The present invention may be methods shown by the above. Furthermore, the methods may be a computer program realized by a computer, and may be a digital signal of the computer program.

(21) Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the digital signal recorded in any of the aforementioned recording medium apparatuses.

(22) Furthermore, the present invention may be the computer program or the digital signal transmitted on an electric communication network, a wireless or wired communication network, or a network of which the Internet is representative.

(23) Also, the present invention may be a computer system including a microprocessor and a memory, whereby the memory stores the computer program, and the microprocessor operates in accordance with the computer program.

(24) Furthermore, by transferring the program or the digital signal to the recording medium, or by transferring the program or the digital signal via a network or the like, the program or the digital signal may be executed by another independent computer system.

(25) The present invention may be any combination of the above-described embodiment and modifications.

What is claimed is:

1. A utilization apparatus which receives service from one or more server apparatuses, each providing service in response to a request made with use of an apparatus key that corresponds with a server key, the utilization apparatus comprising:
a key storage unit storing an old apparatus key and a new apparatus key;
an acquisition unit operable to acquire update completion information indicating one or more server apparatuses, each of which has completed key-updating by updating an old server key corresponding with the old apparatus key to a new server key corresponding with the new apparatus key;
a judgement unit operable to make, with use of the update completion information, a comprehensive judgement on key-updating with respect to a group of at least one server apparatus, from which the utilization apparatus receives service;
a deletion unit operable to, if a result of the comprehensive judgement indicates that the group has completed the key-updating, delete the old apparatus key; and
a utilization unit operable to, if the result of the comprehensive judgement indicates that the group has completed the key-updating, receive service from, among the group, a server apparatus which has updated the old server key to the new server key, with use of the new apparatus key.

2. The utilization apparatus of claim 1, wherein
the update completion information includes identifiers of the one or more server apparatuses each of which has updated the old server key to the new server key, and
the judgement unit (i) holds monitoring target information which includes identifiers of one or more server apparatuses monitored for key-updating and (ii) makes the comprehensive judgement using the identifiers included in the monitoring target information and the identifiers included in the update completion information.

3. The utilization apparatus of claim 2, wherein
the judgement unit makes the comprehensive judgement that the group has completed the key-updating when a ratio of (a) a number of identifiers which are included in both the update completion information and the monitoring target information to (b) a number of the identifiers included in the monitoring target information is equal to or greater than a predetermined ratio.

4. The utilization apparatus of claim 2, wherein
the judgement unit includes:
a registration subunit operable to, when the utilization apparatus accesses a server apparatus, (i) make a determination whether or not an identifier of the accessed server apparatus is included in the monitoring target information, and (ii) if the determination is negative, add the identifier of the accessed server apparatus to the monitoring target information;
a deletion subunit operable to read the monitoring target information and delete, among the identifiers included in the monitoring target information, identifiers of server apparatuses which are less likely to be accessed by the utilization apparatus; and
a judgement subunit operable to make the comprehensive judgement using the identifiers included in the monitoring target information and the identifiers included in the update completion information.

5. The utilization apparatus of claim 1, wherein
the utilization unit, if the result of the comprehensive judgement indicates that the group has not completed the key-updating, receives designation of an apparatus key in accordance with a server key held by a server apparatus of the group, and utilizes the designated apparatus key.

6. A service utilization system comprising one or more server apparatuses, an updating apparatus, and a utilization apparatus, each of the server apparatuses providing service in response to a request made with use of an apparatus key that corresponds with a server key, the updating apparatus distributing an update server key to each server apparatus, and the utilization apparatus receiving service using an apparatus key and a distribution apparatus which distributes update completion information indicating at least one server apparatus that has completed key-updating, wherein each of the server apparatuses includes:
a holding unit operable to hold an old server key;
a key receiving unit operable to receive a transmission of a new server key;
a key updating unit operable to perform the key-updating by replacing the old server key with the new server key; and
a service providing unit operable to provide service, with use of the updated key held by the holding unit, to the utilization apparatus,
the updating apparatus includes:
a generating unit operable to generate, for each of the server apparatuses, a new server key which corresponds with the new apparatus key; and
a key transmitting unit operable to transmit the new server key to each of the server apparatuses;
the distribution apparatus includes:
a collection unit operable to collect information on the at least one server apparatus which has completed the key-updating; and
a distribution unit operable to generate the update completion information and distribute the generated update completion information to the utilization apparatus,
the utilization apparatus includes:
a key storage unit storing an old apparatus key and a new apparatus key;
an acquisition unit operable to acquire the update completion information;
a judgement unit operable to make, with use of the update completion information, a comprehensive judgement on key-updating with respect to a group of at least one server apparatus, from which the utilization apparatus receives service;
a deletion unit operable to, if the result of the comprehensive judgement indicates that the group has completed the key-updating, delete the old apparatus key; and
a utilization unit operable to, if the result of the comprehensive judgement indicates that the group has completed the key-updating, receive service from, among the group, a server apparatus which has updated the old server key to the new server key, with use of the new apparatus key.

7. A service utilization method used for receiving service from one or more server apparatuses, each providing service in response to a request made with use of an apparatus key that corresponds with a server key, the utilization method comprising:
a key storing step of storing an old apparatus key and a new apparatus key;
an acquiring step of acquiring update completion information indicating one or more server apparatuses, each of which has completed key-updating by updating an old server key corresponding with the old apparatus key to a new server key corresponding with the new apparatus key;
a judging step of making, with use of the update completion information, a comprehensive judgement on key-updating with respect to a group of at least one server apparatus, which provides service;
a deleting step of deleting, if a result of the comprehensive judgement indicates that the group has completed the key-updating, the old apparatus key; and
a utilizing step of receiving, if the result of the comprehensive judgement indicates that the group has completed the key-updating, service from, among the group, a server apparatus which has updated the old server key to the new server key, with use of the new apparatus key.

8. A service utilization program used for receiving service from one or more server apparatuses, each providing service in response to a request made with use of an apparatus key that corresponds with a server key, the utilization program comprising:
a key storing step of storing an old apparatus key and a new apparatus key;
an acquiring step of acquiring update completion information indicating one or more server apparatuses, each of which has completed key-updating by updating an old server key corresponding with the old apparatus key to a new server key corresponding with the new apparatus key;
a judging step of making, with use of the update completion information, a comprehensive judgement on key-updating with respect to a group of at least one server apparatus, which provides service;
a deleting step of deleting, if a result of the comprehensive judgement indicates that the group has completed the key-updating, the old apparatus key; and
a utilizing step of receiving, if the result of the comprehensive judgement indicates that the group has completed the key-updating, service from, among the group, a server apparatus which has updated the old server key to the new server key, with use of the new apparatus key.

9. An integrated circuit used by a utilization apparatus which receives service from one or more server apparatuses, each providing service in response to a request made with use of an apparatus key that corresponds with a server key, the utilization apparatus comprising:
a key storage unit storing an old apparatus key and a new apparatus key;
an acquisition unit operable to acquire update completion information indicating one or more server apparatuses, each of which has completed key-updating by updating an old server key corresponding with the old apparatus key to a new server key corresponding with the new apparatus key;
a judgement unit operable to make, with use of the update completion information, a comprehensive judgement on key-updating with respect to a group of at least one server apparatus, from which the utilization apparatus receives service;
a deletion unit operable to, if a result of the comprehensive judgement indicates that the group has completed the key-updating, delete the old apparatus key; and
a utilization unit operable to, if the result of the comprehensive judgement indicates that the group has completed the key-updating, receive service from, among the group, a server apparatus which has updated the old server key to the new server key, with use of the new apparatus key.
